(19) United States
(12) Patent Application Publication
(10) Pub. No.: US 2026/0081176 A1
(43) Pub. Date: Mar. 19, 2026

(54) ELECTRODE ASSEMBLY, SECONDARY BATTERY AND METHOD FOR MANUFACTURING THE ELECTRODE ASSEMBLY

(71) Applicant: SAMSUNG SDI CO., LTD., Yongin-Si (KR)

(72) Inventors: Hanbyeol JANG, Yongin-si (KR); Taesu JEONG, Yongin-si (KR); Jungah YOON, Yongin-si (KR); Eunhyeok SHIN, Yongin-si (KR)

(21) Appl. No.: 19/213,550

(22) Filed: May 20, 2025

(30) Foreign Application Priority Data
Sep. 13, 2024 (KR) 10-2024-0125838

(51) Int. Cl. H01M 4/66; H01M 4/36; H01M 10/04; H01M 50/105

(52) U.S. Cl. CPC H01M 4/667; H01M 4/366; H01M 10/0431; H01M 50/105

(57) ABSTRACT

The present disclosure relates to an electrode assembly, a secondary battery, and a method for manufacturing the electrode assembly. The electrode assembly according to an embodiment of the present disclosure may include a first electrode, a second electrode, and a separator positioned between the first electrode or the second electrode. At least one of the first electrode and the second electrode may include an insulating layer, a first conductive layer, and a second conductive layer, where the first conductive layer and the second conductive layer are respectively positioned on opposite surfaces of the insulating layer, and one end of each of the first conductive layer and the second conductive layer may extend beyond the insulating layer in a longitudinal direction.

### CROSS-REFERENCE TO RELATED APPLICATION

The present application claims priority to and the benefit of Korean Application No. 10-2024-0125838, filed on Sep. 13, 2024, in the Korean Intellectual Property Office, the entire disclosure of which is incorporated by reference herein.

### BACKGROUND

### 1. Field

Aspects of embodiments of the present disclosure relate to an electrode assembly, a secondary battery, and a method for manufacturing the electrode assembly.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In line with the advancement of digital convergence, electronic devices and/or automobiles provide various functions and/or various services connected or linked thereto. For example, technologies have been proposed to improve the performance of secondary batteries, which are used for the operation of electronic devices and/or automobiles. For example, a mixture substrate may be used where a metal substrate of an electrode included in a secondary battery includes an insulating substrate and metal substrates on opposite surfaces thereof. The mixture substrate may help reduce the weight of the secondary battery by replacing a part of an existing metal substrate with an insulating substrate.

Due to the insulating properties of the mixture substrate, electrical connection of metal substrates between the insulating substrates may not be possible. The mixture substrate may be considered as a structure in which separate conductive substrates (e.g., electrode tabs) are welded to metal substrates and electrically connected to external components (e.g., electrode leads) through the conductive substrates. The process of welding the conductive substrates to the metal substrates may cause defects (e.g., pinholes) in at least some of the metal substrates, which may deteriorate the mechanical strength and/or electrical performance of the electrode based on the mixture substrate.

The above information disclosed in this Background section is for enhancement of understanding of the background of the present disclosure, and therefore, it may contain information that does not constitute related (or prior) art.

### SUMMARY

To solve the problems described above, aspects of embodiments of the present disclosure provide an electrode assembly, a secondary battery, and a method for manufacturing the electrode assembly.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

An electrode assembly according to an embodiment of the present disclosure may include a first electrode, a second electrode, and a separator positioned between the first electrode and the second electrode.

According to an embodiment of the present disclosure, at least one of the first electrode and the second electrode may include an insulating layer, a first conductive layer, and a second conductive layer, where the first conductive layer and the second conductive layer are respectively positioned on opposite surfaces of the insulating layer.

According to an embodiment of the present disclosure, one end of each of the first conductive layer and the second conductive layer may extend beyond the insulating layer in a longitudinal direction.

According to an embodiment of the present disclosure, each of the first conductive layer and the second conductive layer may include a mixture portion and an uncoated portion.

According to an embodiment of the present disclosure, one end of each of the first conductive layer and the second conductive layer, which extends beyond the insulating layer in the longitudinal direction, may include at least a part of the uncoated portion.

According to an embodiment of the present disclosure, the uncoated portion of each of the first conductive layer and the second conductive layer are arranged in an air gap space.

According to an embodiment of the present disclosure, the uncoated portion of each of the first conductive layer and the second conductive layer may have a first length and a part of the insulating layer overlapping the uncoated portion of each of the first conductive layer and the second conductive layer may have a second length less than the first length.

According to an embodiment of the present disclosure, the one end of the insulating layer may include a substantially curved surface.

According to an embodiment of the present disclosure, the electrode assembly may further include a conductive strip member physically connected to the one end of each of the first conductive layer and the second conductive layer which extends beyond the insulating layer in the longitudinal direction.

According to an embodiment of the present disclosure, a part of the first conductive layer and a part of the second conductive layer may surround one end of the insulating layer and be physically connected to the conductive strip member.

According to an embodiment of the present disclosure, a part of the first conductive layer and a part of the second conductive layer may surround one end of the insulating layer and be physically connected to the conductive strip member, and the part of the first conductive layer and the part of the second conductive layer surrounding the one end of the insulating layer are arranged in an air gap space.

A secondary battery according to an embodiment of the present disclosure may include an electrode assembly comprising a first electrode, a second electrode, and a separator positioned between the first electrode and the second electrode, and a case configured to accommodate at least a part of the electrode assembly.

According to an embodiment of the present disclosure, at least one of the first electrode and the second electrode may include an insulating layer, and a first conductive layer, a second conductive layer, where the first conductive layer and the second conductive layer are respectively positioned on opposite surfaces of the insulating layer.

According to an embodiment of the present disclosure, one end of each of the first conductive layer and the second conductive layer may extend beyond the insulating layer in a longitudinal direction.

According to an embodiment of the present disclosure, each of the first conductive layer and the second conductive layer may include a mixture portion and an uncoated portion.

According to an embodiment of the present disclosure, the one end of each of the first conductive layer and the second conductive layer, which extends beyond the insulating layer in the longitudinal direction, may include at least a part of the uncoated portion.

According to an embodiment of the present disclosure, the uncoated portion of each of the first conductive layer and the second conductive layer are arranged in an air gap space.

According to an embodiment of the present disclosure, the uncoated portion of each of the first conductive layer and the second conductive layer may have a first length and a part of the insulating layer overlapping the uncoated portion of each of the first conductive layer and the second conductive layer may have a second length less than the first length.

According to an embodiment of the present disclosure, one end of the insulating layer may include a substantially curved surface.

According to an embodiment of the present disclosure, the electrode assembly may further include a conductive strip member physically connected to one end of each of the first conductive layer and the second conductive layer, which extends beyond the insulating layer in the longitudinal direction.

According to an embodiment of the present disclosure, a part of the first conductive layer and a part of the second conductive layer may surround one end of the insulating layer and be physically connected to the conductive strip member.

According to an embodiment of the present disclosure, a part of the first conductive layer and a part of the second conductive layer may surround one end of the insulating layer and be physically connected to the conductive strip member, and the part of the first conductive layer and the part of the second conductive layer surrounding the one end of the insulating layer are arranged in an air gap space.

A method for manufacturing an electrode assembly including a first electrode, a second electrode, and a separator positioned between the first electrode and the second electrode according to an embodiment of the present disclosure may include preparing an insulation layer, positioning a first conductive layer and a second conductive layer respectively on opposite surfaces of the insulating layer, and removing a part of the insulating layer to extend one end of each of the first conductive layer and the second conductive layer extends in a longitudinal direction.

According to an embodiment of the present disclosure, the method for manufacturing may further include forming a mixture portion and an uncoated portion on each of the first conductive layer and the second conductive layer.

According to an embodiment of the present disclosure, the removing of the part of the insulating layer may include removing the part of the insulating layer such that one end of each of the first conductive layer and the second conductive layer, which extends beyond the insulating layer in the longitudinal direction, includes at least a part of the uncoated portion.

According to an embodiment of the present disclosure, the removing of the part of the insulating layer such that the one end of each of the first conductive layer and the second conductive layer include at least a part of the uncoated portion may include removing a part of the insulating layer such that the uncoated portion of each of the first conductive layer and the second conductive layer has a first length and a part of the insulating layer overlapping the uncoated portion of each of the first conductive layer and the second conductive layer has a second length less than the first length.

According to an embodiment of the present disclosure, the method for manufacturing may further include physically connecting one end of each of the first conductive layer and the second conductive layer, which extends beyond the insulating layer in the longitudinal direction, to a conductive strip member.

According to various embodiments of the present disclosure, in the mixture substrate including the insulating substrate and the metal substrates on opposite surfaces thereof, the mechanism capable of electrically connecting the metal substrates based on the structural improvement of the insulating substrate may be provided.

According to various embodiments of the present disclosure, the mechanism may be provided for connecting (e.g., directly connecting) metal substrates to external components (e.g., electrode leads) by electrically connecting the metal substrates based on the structural improvement of the insulating substrate.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 shows an example of a secondary battery according to an embodiment of the present disclosure.

FIG. 2 illustrates an example of a mixture substrate.

FIG. 3 illustrates an example of a mixture substrate according to an embodiment of the present disclosure.

FIG. 4 illustrates another example of a mixture substrate according to an embodiment of the present disclosure.

FIG. 5 shows an example of a mixture substrate and a conductive strip member according to an embodiment of the present disclosure.

FIG. 6 illustrates an example of a physical connection between a mixture substrate and a conductive strip member according to an embodiment of the present disclosure.

FIG. 7 illustrates another example of a physical connection between a mixture substrate and a conductive strip member according to an embodiment of the present disclosure.

FIG. 8 illustrates an example of a method for manufacturing an electrode assembly according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way. The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, etc. may be used herein to describe various elements, these elements should not be limited by these terms. These terms are used to distinguish one element from another element. Thus, a first element discussed below could be termed a second element without departing from the teachings of example embodiments.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

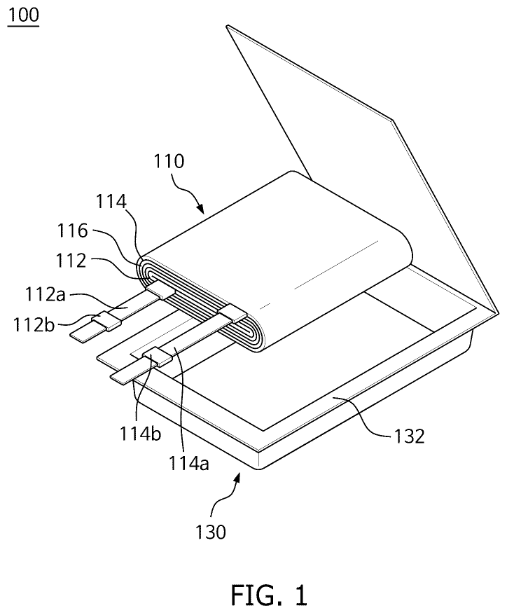

FIG. 1 shows an example of a secondary battery according to an embodiment of the present disclosure. Referring to FIG. 1, a secondary battery 100 according to an embodiment may include an electrode assembly 110 and a case 130 that accommodates at least a part of the electrode assembly 110. Although not shown, according to various embodiments, the secondary battery 100 may further include an electrolyte that is stored in the case 130 and impregnates at least a part of the electrode assembly 110.

An electrode assembly 110 may be formed by winding or stacking a stack of a first electrode 112, a second electrode 114, and a separator 116 disposed between the first electrode 112 and the second electrode 114, which are formed as thin plates or films. When the electrode assembly 110 is a wound stack, a winding axis may be parallel to the longitudinal direction of the case 130. In addition, the electrode assembly 110 may be a stack type rather than a winding type, and the type of the electrode assembly 110 is not limited in the present disclosure. In addition, the electrode assembly 110 may be a Z-stack type in which the first electrode 112 and the second electrode 114 are inserted into both sides of a separator 116, which is then bent into a Z-stack. In addition, one or more electrode assemblies 110 may be stacked such that long sides of the electrode assemblies 110 are adjacent to each other and accommodated in the case 130, and the number of electrode assemblies 110 in the case 130 is not limited in the present disclosure. The first electrode 112 of the electrode assembly 110 may act as a negative electrode, and the second electrode 114 may act as a positive electrode. Of course, the reverse is also possible.

The first electrode 112 may be formed by applying a first electrode active material, such as graphite or carbon, to a first electrode current collector formed of a metal foil, such as copper, a copper alloy, nickel, or a nickel alloy. The first electrode 112 may include a first uncoated portion that is a region to which the first electrode active material is not applied. The first uncoated portion may act as a current flow path between the first electrode 112 and the first current collector.

The second electrode 114 may be formed by applying a second electrode active material, such as a transition metal oxide, on a second electrode current collector formed of a metal foil, such as aluminum or an aluminum alloy. The second electrode 114 may include a second uncoated portion that is a region to which the second electrode active material is not applied. The second uncoated portion may act as a current flow path between the second electrode 114 and the second current collector.

A first uncoated portion of the first electrode 112 and a second uncoated portion of the second electrode 114 may be welded to a negative strip member 112a and a positive strip member 114a of an external terminal and thus electrically connected to the outside. A tab film 112b for insulation from the case 130 may be attached to the negative strip member 112a. Similarly, a tab film 114b for insulation from the case 130 may be attached to the positive strip member 114a.

In a state in which the electrode assembly 110 is accommodated in the case 130, sealing parts 132 of edges of the case 130 come into contact with each other to be sealed. The sealing is performed in a state in which the tab film 112b and 114b is disposed between the sealing parts 132. The sealing parts 132 of the case 130 may be made of a heat-fusible material. In various embodiments, after sealing of the case 130, the sealing parts 132 may be at least partially removed.

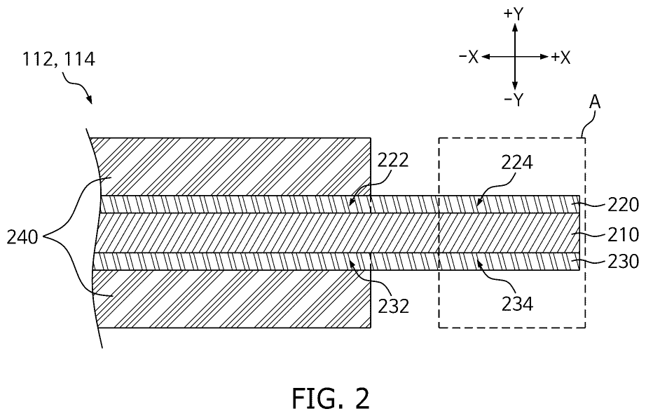

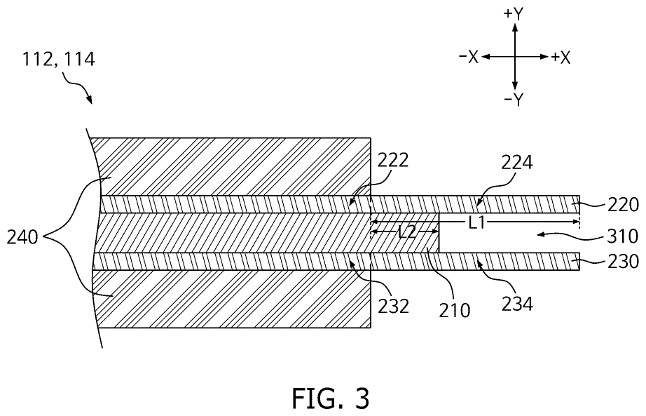

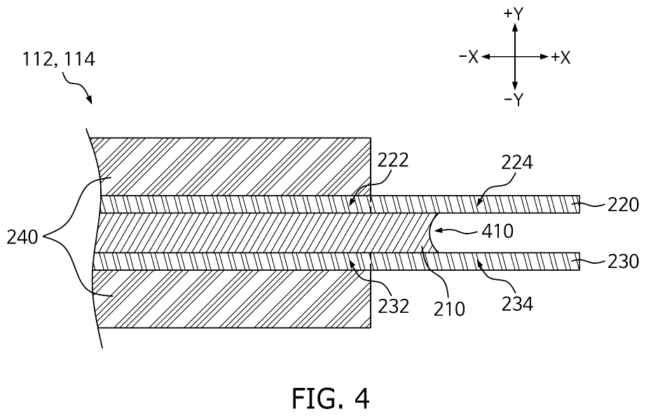

FIG. 2 illustrates an example of a mixture substrate. FIG. 3 illustrates an example of a mixture substrate according to an embodiment of the present disclosure. FIG. 4 illustrates another example of a mixture substrate according to an embodiment of the present disclosure. Referring to FIGS. 2 and 3, an electrode (e.g., the first electrode 112 or the second electrode 114) of an electrode assembly (e.g., the electrode assembly 110 of FIG. 1) according to an embodiment may include an insulating layer 210, and a first conductive layer 220 and a second conductive layer 230 respectively positioned on opposite surfaces of the insulating layer 210. In various embodiments, the combination (or stacked structure) of the insulating layer 210, the first conductive layer 220, and the second conductive layer 230 may be referred to as a mixture substrate.

In an embodiment, the insulating layer 210 may be made of a polymer material having a first thickness (e.g., about 5 μm). For example, the insulating layer 210 may be configured to include polypropylene or polyethylene terephthalate having elongation properties. In various embodiments, the elongation of the insulating layer 210 may be related to a short circuit of the first conductive layer 220 and the second conductive layer 230. For example, the insulating layer 210 having elongation properties may reduce the chance or prevent the first conductive layer 220 and the second conductive layer 230 from coming into physical contact with each other in a case where the first conductive layer 220 or the second conductive layer 230 is damaged by an external object (e.g., penetration by an external object), and help minimize the possibility of a short circuit. In various embodiments, the material of the insulating layer 210 is not limited to the exemplified polypropylene or polyethylene terephthalate and may be configured to include other materials not exemplified herein as long as the material has excellent or a threshold amount of elongation and insulating properties.

In an embodiment, one or more (e.g., each) of the first conductive layer 220 and the second conductive layer 230 may be made of the same metal material having a second thickness (e.g., about 2 μm). For example, the first conductive layer 220 and the second conductive layer 230 may be configured to include aluminum or copper.

In various embodiments, in a case where the first conductive layer 220 and the second conductive layer 230 are made of aluminum, an active material 240 positioned in a part of one or more (e.g., each) of the first conductive layer 220 and the second conductive layer 230 may be a positive electrode active material, and the combination of the positive electrode active material, the insulating layer 210, the first conductive layer 220, and the second conductive layer 230 may function as a positive electrode. In some embodiments, in a case where the first conductive layer 220 and the second conductive layer 230 are composed of copper, the active material 240 positioned in a part of one or more (e.g., each) of the first conductive layer 220 and the second conductive layer 230 may be a negative electrode active material, and the combination of the negative electrode active material, the insulating layer 210, the first conductive layer 220, and the second conductive layer 230 may function as a negative electrode.

In an embodiment, the first conductive layer 220 and the second conductive layer 230 may include mixture portions 222 and 232 on which the active material 240 is positioned, and uncoated portions 224 and 234 which are regions other than the mixture portions (e.g., an exposed region where the active material 240 is not positioned).

In an embodiment, the insulating layer 210 of the electrode 112 or 114 may be partially removed through a specified process. For example, after the mixture substrate is formed by coating (e.g., depositing and plating) the first conductive layer 220 and the second conductive layer 230 on respectively opposite surfaces of the insulating layer 210, a part of the insulating layer 210 may be removed by immersing a portion (e.g., region A) of the mixture substrate in a specified solvent that does not react with the first conductive layer 220 and the second conductive layer 230. In some embodiments, for example, after the electrode 112 or 114 is formed by positioning (e.g., applying and drying) the active material 240 on the mixture substrate, a part of the insulating layer 210 may be removed by immersing a portion (e.g., region A) of the electrode 112 or 114 in a specified solvent.

In various embodiments, in a case where the insulating layer 210 is formed of polypropylene, a hydrocarbon (e.g., benzene or toluene) having a specified temperature (e.g., a temperature of 80° C. or higher) may be used as the solvent. In some embodiments, in a case where the insulating layer 210 is composed of polyethylene terephthalate, alcohol may be used as the solvent.

In various embodiments, a part of the insulating layer 210 to be removed may be determined based on the entire volume or the entire length of the insulating layer 210. For example, a part of the insulating layer 210 having a volume of a specified ratio with respect to the entire volume of the insulating layer 210 may be removed. In some embodiments, for example, a part of the insulating layer 210 having a length of a specified ratio based on the total length of the insulating layer 210 (e.g., lengths in the +X direction and the −X direction) may be removed.

According to an embodiment, as a part of the insulating layer 210 is removed, one end of one or more (e.g., each) of the first conductive layer 220 and the second conductive layer 230 facing the first direction (e.g., the +X direction) may extend beyond or further than the insulating layer 210. For example, one end of the first conductive layer 220 and one end of the second conductive layer 230 extending further than the insulating layer 210 may include at least a part of the uncoated portions 224 and 234, and the uncoated portions 224 and 234 may relatively extend (or protrude) further than the insulating layer 210.

In an embodiment, as a part of the insulating layer 210 is removed, the uncoated portions 224 and 234 of the first conductive layer 220 and the second conductive layer 230 may have a longer length than the overlapping insulating layer 210. For example, the uncoated portions 224 and 234 of the first conductive layer 220 and the second conductive layer 230 may have a first length L1, and another portion of the insulating layer 210 overlapping the uncoated portions 224 and 234 may have a second length L2 less than the first length.

In an embodiment, based on the insulating layer 210 being removed, an air gap, clearance space, or unobstructed space (used interchangeably herein) 310 may be formed between the uncoated portions 224 and 234 of the first conductive layer 220 and the second conductive layer 230. For example, the air gap 310 corresponding to the volume of the removed portion of the insulating layer 210 may be formed between at least parts of the uncoated portions 224 and 234 of the first conductive layer 220 and the second conductive layer 230. In this regard, the uncoated portions 224 and 234 of the first conductive layer 220 and the second conductive layer 230 may be arranged in the air gap space 310.

Although not shown, in various embodiments, parts of the insulating layer 210 which overlap the uncoated portions 224 and 234 of the first conductive layer 220 and the second conductive layer 230 may be all removed. In this case, one end of the insulating layer 210, which is removed by the solvent, the first direction (e.g., the +X direction) may be substantially aligned with one end of the uncoated portions 224 and 234 in the second direction (e.g., the −X direction) with respect to the third direction (e.g., the +Y direction) or the fourth direction (e.g., the −Y direction).

Referring to FIGS. 2 and 4, in the process of immersing the mixture substrate (e.g., the combination of the insulating layer 210, the first conductive layer 220, and the second conductive layer 230) or a portion (e.g., region A) of the electrode 112 or 114 in the specified solvent, one end of the insulating layer 210 in the first direction (e.g., the +X direction) may be formed into a specified shape. For example, due to the surface tension of the solvent, the insulating layer 210 may react (e.g., dissolve) with the solvent relatively quickly in the center region between the edge regions, compared to the edge regions facing the third direction (e.g., the +Y direction) and the fourth direction (e.g., the −Y direction). Based on this, one end of the removed insulating layer 210 facing the first direction (e.g., the +X direction) may be formed in a substantially curved shape 410 that is directed toward the second direction (e.g., the −X direction). According to various embodiments, an irregular pattern may be formed at one end of the insulating layer 210 having the curved shape.

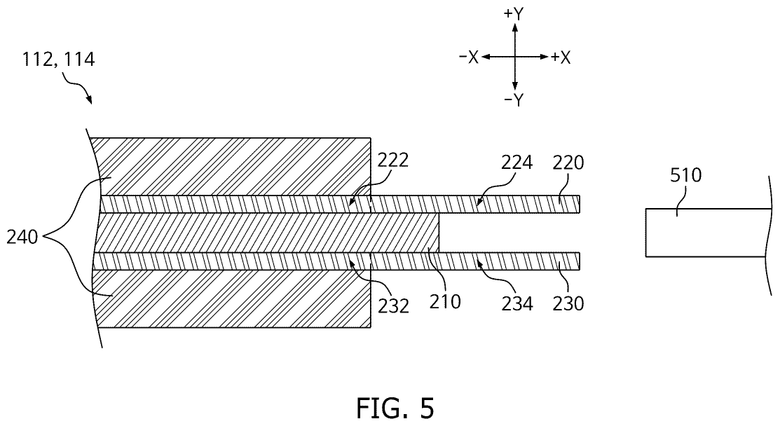

FIG. 5 shows an example of a mixture substrate and a conductive strip member according to an embodiment of the present disclosure. Referring to FIG. 5, an electrode assembly according to an embodiment (e.g., the electrode assembly 110 of FIG. 1) may further include a conductive strip member 510 (e.g., an electrode lead) electrically connected to the electrode 112 or 114. For example, the conductive strip member 510 may be physically and electrically connected (e.g., by laser welding or ultrasonic welding) to one end of the first conductive layer 220 and the second conductive layer 230 (e.g., at least a part of the uncoated portions 224 and 234) that extend beyond the insulating layer 210 (e.g., are longer than the insulating layer) in the longitudinal direction (e.g., in the +X direction) as a part of the insulating layer 210 is removed.

According to an embodiment, the removed portion of the insulating layer 210 or an air gap formed thereby (e.g., the air gap 310 of FIG. 3) may provide a space where the first conductive layer 220 and the second conductive layer 230 may physically contact each other so as to be electrically connected to each other. For example, one end of the first conductive layer 220 and one end of the second conductive layer 230 (e.g., at least a part of the uncoated portions 224 and 234) may physically contact each other so as to be electrically connected to each other in the space where the air gap 310 is formed.

In some embodiments, the first conductive layer 220 and the second conductive layer 230 may be directly connected to the conductive strip member 510 without a separate conductive substrate (e.g., an electrode tab) that supports electrical connection with the conductive strip member 510.

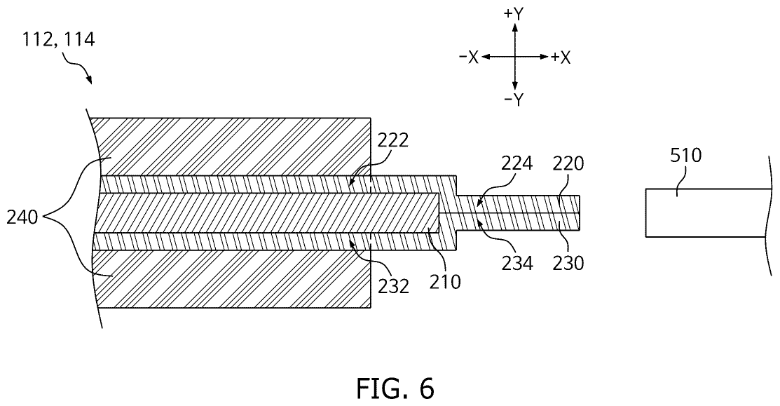

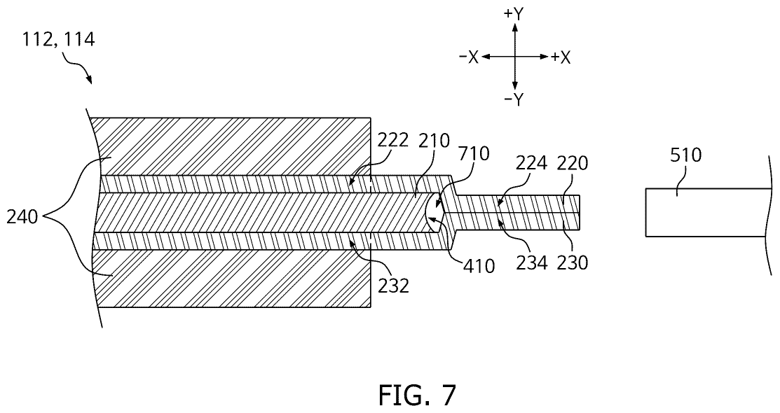

FIG. 6 illustrates an example of a physical connection between a mixture substrate and a conductive strip member according to an embodiment of the present disclosure. FIG. 7 illustrates another example of a physical connection between a mixture substrate and a conductive strip member according to an embodiment of the present disclosure. Referring to FIG. 6, one end of the first conductive layer 220 and one end of the second conductive layer 230 of the electrode 112 or 114 according to an embodiment may be physically and electrically connected to surround at least a part of the insulating layer 210. For example, at least a part of the uncoated portions 224 and 234 of the first conductive layer 220 and the second conductive layer 230 may be physically and electrically connected to one end of the insulating layer 210 facing the first direction (e.g., the +X direction).

In an embodiment of the present disclosure, the uncoated portions 224 and 234 of the first conductive layer 220 and the second conductive layer 230 may be partially bent in the air gap (e.g., the air gap 310 of FIG. 3) formed by removing a part of the insulating layer 210 so as to surround one end of the insulating layer 210 facing the first direction (e.g., the +X direction). For example, the uncoated portions 224 and 234 of the first conductive layer 220 and the second conductive layer 230 may be bent toward the fourth direction (e.g., the −Y direction) and the third direction (e.g., the +Y direction) to contact one end of the insulating layer 210 and may be bent toward the first direction (e.g., the +X direction) for physical and electrical connection with the conductive strip member 510.

According to an embodiment of the present disclosure, at least a part of the uncoated portions 224 and 234 of the first conductive layer 220 and the second conductive layer 230 that are at least partially bent and physically connected may be physically and electrically connected (e.g., by laser welding or ultrasonic welding) to the conductive strip member 510.

Referring to FIG. 7, in a case where one end of the removed insulating layer 210 in the first direction (e.g., the +X direction) is configured in the curved shape 410, the uncoated portions 224 and 234 of the first conductive layer 220 and the second conductive layer 230, which are bent so as to be physically connected to each other, may not come into contact with one end of the insulating layer 210. In this case, an air gap 710 may be formed between one end of the insulating layer 210 and the uncoated portions 224 and 234 of the first conductive layer 220 and the second conductive layer 230 surrounding the insulating layer 210.

In the embodiments of FIGS. 6 and 7, a structure is exemplified in which the uncoated portions 224 and 234 of the first conductive layer 220 and the second conductive layer 230 surround one end of the insulating layer 210 facing the first direction (e.g., the +X direction) and are physically connected to each other, but the present disclosure is not limited thereto. For example, the uncoated portions 224 and 234 of the first conductive layer 220 and the second conductive layer 230 may be bent in a structure having other shapes that are not shown in the drawings, and physically and electrically connected to the conductive strip member 510 in embodiments where the uncoated portions 224 and 234 surround one end of the insulating layer 210 in a contact or non-contact manner, and are physically connected to each other.

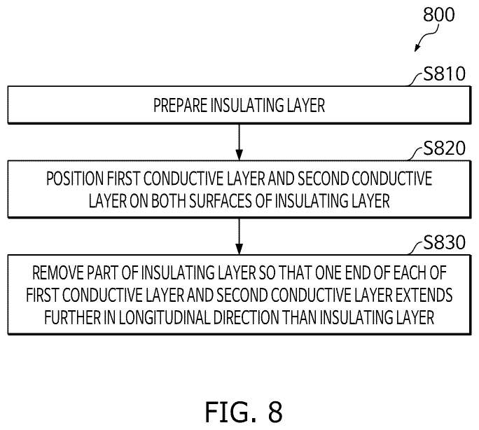

FIG. 8 illustrates an example of a method for manufacturing an electrode assembly according to an embodiment of the present disclosure. Hereinafter, operations of a method 800 described with respect to the embodiment of FIG. 8 may be performed sequentially or non-sequentially. For example, the order of the operations of the method 800 described with respect to the embodiment of FIG. 8 may be changed, or at least two operations may be performed in parallel.

In addition, the method described with respect to the embodiment of FIG. 8 describes operations of manufacturing an electrode included in an electrode assembly, for example, an electrode having a structure that may be directly connected (e.g., welded) to a conductive strip member (e.g., an electrode lead) based on a mixture substrate including a combination (or a stacked structure) of an insulating layer, a first conductive layer, and a second conductive layer. In addition, an electrode assembly and a secondary battery according to embodiments of the present disclosure may be configured to include an electrode manufactured through the embodiment of FIG. 8.

Referring to FIG. 8, in operation S810, an insulating layer (e.g., the insulating layer 210 of FIG. 2) that constitutes of forms part of an electrode (e.g., the first electrode 112 or the second electrode 114 of FIG. 1) of an electrode assembly (e.g., the electrode assembly 110 of FIG. 1) according to an embodiment may be prepared.

In an embodiment, the insulating layer 210 may be made of a polymer material having a first thickness (e.g., about 5 μm). For example, the insulating layer 210 may be configured to include polypropylene or polyethylene terephthalate having excellent elongation and/or insulating properties (e.g., elongation and/or insulating properties of a minimum threshold level).

In operation S820, a first conductive layer (e.g., the first conductive layer 220 of FIG. 2) and a second conductive layer (e.g., the second conductive layer 230 of FIG. 2) may be respectively positioned on opposite surfaces of the insulating layer 210.

In an embodiment of the present disclosure, one or more (e.g., each) of the first conductive layer 220 and the second conductive layer 230 may be made of the same metal material having a second thickness (e.g., about 2 μm). For example, the first conductive layer 220 and the second conductive layer 230 may be configured to include aluminum or copper.

According to various embodiments, an active material may be positioned in a part of one or more (e.g., each) of the first conductive layer 220 and the second conductive layer 230 before or after the first conductive layer 220 and the second conductive layer 230 are positioned on opposite surfaces of the insulating layer 210.

In operation S830, a part or portion of the insulating layer 210 may be removed so that one end of one or more (e.g., each) of the first conductive layer 220 and the second conductive layer 230 extends further or beyond the insulating layer 210 in the longitudinal direction. For example, a part of the insulating layer 210 may be removed by immersing a mixture substrate (e.g., the combination or the stacked structure of the insulating layer 210, the first conductive layer 220, and the second conductive layer 230) on which an active material is positioned, in a specified solvent (e.g., the hydrocarbon or alcohol having a specified temperature) that does not substantially react (e.g., reacts up to a maximum threshold amount) with the first conductive layer 220 and the second conductive layer 230.

According to an embodiment of the present disclosure, the removed portion of the insulating layer 210 or an air gap formed between the first conductive layer 220 and the second conductive layer 230 accordingly (e.g., the air gap 310 of FIG. 3) may provide a space through which a part of the first conductive layer 220 and a part of the second conductive layer 230 may be physically connected (or in contact with) each other. In an embodiment of the present disclosure, a part of each of the first conductive layer 220 and the second conductive layer 230 (e.g., at least a part of the uncoated portion of the first conductive layer 220 and the second conductive layer 230) may be physically connected to each other through a bent structure in the air gap 310 formed by removing a part of the insulating layer 210. For example, the first conductive layer 220 and the second conductive layer 230 may bend towards one other in the space (e.g., the air gap space) that is generated by removing a part of the insulating layer 210, and the bent portions may come in contact with one another in the space. The part of the first conductive layer 220 and the part of the second conductive layer 230, which are physically connected to each other may be physically and electrically connected to a conductive strip member (e.g., the conductive strip member 510 of FIG. 5).

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. An electrode assembly comprising:
a first electrode;
a second electrode; and
a separator positioned between the first electrode and the second electrode,
wherein at least one of the first electrode or the second electrode comprises:
an insulating layer;
a first conductive layer; and
a second conductive layer,
wherein the first conductive layer and the second conductive layer are respectively positioned on opposite surfaces of the insulating layer,
wherein one end of each of the first conductive layer and the second conductive layer extends beyond the insulating layer in a longitudinal direction.

2. The electrode assembly as claimed in claim 1, wherein the first conductive layer and the second conductive layer each comprise a mixture portion and an uncoated portion,
wherein the one end of each of the first conductive layer and the second conductive layer, which extends beyond the insulating layer in the longitudinal direction, comprises at least a part of the uncoated portion.

3. The electrode assembly as claimed in claim 2, wherein the uncoated portion of each of the first conductive layer and the second conductive layer are arranged in an air gap space.

4. The electrode assembly as claimed in claim 2, wherein the uncoated portion of each of the first conductive layer and the second conductive layer has a first length,
wherein a part of the insulating layer overlapping the uncoated portion of each of the first conductive layer and the second conductive layer has a second length less than the first length.

5. The electrode assembly as claimed in claim 1, wherein the one end of the insulating layer comprises a substantially curved surface.

6. The electrode assembly as claimed in claim 1, further comprising a conductive strip member physically connected to the one end of each of the first conductive layer and the second conductive layer which extends beyond the insulating layer in the longitudinal direction.

7. The electrode assembly as claimed in claim 6, wherein a part of the first conductive layer and a part of the second conductive layer surround one end of the insulating layer and are physically connected to the conductive strip member.

8. The electrode assembly as claimed in claim 6, wherein a part of the first conductive layer and a part of the second conductive layer surround one end of the insulating layer and are physically connected to the conductive strip member,
wherein the part of the first conductive layer and the part of the second conductive layer surrounding the one end of the insulating layer are arranged in an air gap space.

9. A secondary battery comprising:
an electrode assembly comprising a first electrode, a second electrode, and a separator positioned between the first electrode and the second electrode; and
a case configured to accommodate at least a part of the electrode assembly,
wherein at least one of the first electrode or the second electrode comprises:
an insulating layer;
a first conductive layer; and
a second conductive layer,
wherein the first conductive layer and the second conductive layer are respectively positioned on opposite surfaces of the insulating layer,
wherein one end of each of the first conductive layer and the second conductive layer extends beyond the insulating layer in a longitudinal direction.

10. The secondary battery as claimed in claim 9, wherein the first conductive layer and the second conductive layer each comprise a mixture portion and an uncoated portion,
wherein the one end of each of the first conductive layer and the second conductive layer, which extends beyond the insulating layer in the longitudinal direction, comprises at least a part of the uncoated portion.

11. The secondary battery as claimed in claim 10, wherein the uncoated portion of each of the first conductive layer and the second conductive layer are arranged in an air gap space.

12. The secondary battery as claimed in claim 10, wherein the uncoated portion of each of the first conductive layer and the second conductive layer has a first length,
wherein a part of the insulating layer overlapping the uncoated portion of each of the first conductive layer and the second conductive layer has a second length less than the first length.

13. The secondary battery as claimed in claim 9, wherein one end of the insulating layer comprises a substantially curved surface.

14. The secondary battery as claimed in claim 9, wherein the electrode assembly further comprises a conductive strip member physically connected to the one end of each of the first conductive layer and the second conductive layer which extends beyond the insulating layer in the longitudinal direction.

15. The secondary battery as claimed in claim 14, wherein a part of the first conductive layer and a part of the second conductive layer surround one end of the insulating layer and are physically connected to the conductive strip member.

16. The secondary battery as claimed in claim 14, wherein a part of the first conductive layer and a part of the second conductive layer surround one end of the insulating layer and are physically connected to the conductive strip member,
wherein the part of the first conductive layer and the part of the second conductive layer surrounding the one end of the insulating layer are arranged in an air gap space.

17. A method for manufacturing an electrode assembly including a first electrode, a second electrode, and a separator positioned between the first electrode and the second electrode, the method comprising:
preparing an insulation layer;
positioning a first conductive layer and a second conductive layer respectively on opposite surfaces of the insulating layer; and
removing a part of the insulating layer to extend one end of each of the first conductive layer and the second conductive layer beyond the insulating layer in a longitudinal direction.

18. The method as claimed in claim 17, further comprising forming a mixture portion and an uncoated portion on each of the first conductive layer and the second conductive layer,
wherein the removing of the part of the insulating layer comprises removing the part of the insulating layer such that one end of each of the first conductive layer and the second conductive layer, which extends beyond the insulating layer in the longitudinal direction, includes at least a part of the uncoated portion.

19. The method as claimed in claim 18, wherein the removing of the part of the insulating layer such that the one end of each of the first conductive layer and the second conductive layer comprise at least a part of the uncoated portion comprises:
removing a part of the insulating layer such that the uncoated portion of each of the first conductive layer and the second conductive layer has a first length and a part of the insulating layer overlapping the uncoated portion of each of the first conductive layer and the second conductive layer has a second length less than the first length.

20. The method as claimed in claim 17, further comprising physically connecting one end of each of the first conductive layer and the second conductive layer which extends beyond the insulating layer in the longitudinal direction, to a conductive strip member.
